(19) United States
(12) Patent Application Publication
(10) Pub. No.: US 2004/0204068 A1
(43) Pub. Date: Oct. 14, 2004

(54) Mobile communication system and method, mobile communication terminal, server apparatus and program

(75) Inventor: Kaoru Komaki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/817,845

(22) Filed: Apr. 6, 2004

(30) Foreign Application Priority Data
Apr. 10, 2003 (JP) 2003-106026

(51) Int. Cl. H04M 1/00

(52) U.S. Cl. 455/556.1

(57) ABSTRACT

It is an object of the invention to provide a mobile communication system in which a voice communication and an IM (instant message) communication are organically linked.

The first and second terminals can perform the voice communication and the IM communication at the same time. When there is a call incoming from the second terminal to the first terminal in the voice communication, if the user inputs a command of using the IM communication at the same time, the first terminal enables the voice communication by returning a response to the incoming call, and automatically setting the second terminal of the other party originating the incoming call as an IM transmission destination by starting an IM communication application program, whereby the first terminal is ready for transmitting promptly an IM to the second terminal. Thereby, it is possible that the first terminal responds in the IM communication rapidly when receiving a call at the place where there is an obstacle to respond in speech such as within a train.

### BACKGROUND OF THE INVENTION

1. Field of the Invention

The present invention relates to a mobile communication terminal such as a portable telephone set capable of performing the voice communication and the data communication at the same time, and more particularly to a mobile communication terminal and a mobile communication system in which an instant message communication is employed as the data communication.

2. Description of the Prior Art

Various types of mobile communication terminals having both a voice communication function and a data communication function have been conventionally proposed. For example, in patent document 1 which will be mentioned later, a mobile communication terminal has been proposed in which the sending speech or the information code data is transmitted on the same line by switching between them. However, since the mobile communication terminal of this type can not transmit voice and data at the same time, the user can not transmit data while listening to a speech of the other party, whereby any one of the voice communication and the data communication is allowed at a time. On the contrary, in patent document 2 which will be mentioned later, a mobile communication terminal having a multi-call function capable of making the voice communication and the data communication at the same time has been described. Also, in patent document 3 which will be mentioned later, a mobile terminal communication has been proposed which can make the voice communication with any one of PDC (Personal Digital Cellular) and PHS (Personal Handyphone System) and the data communication with the other. Employing these mobile terminal terminals, the speech and data communication can be made in parallel.

On the other hand, a document describing the techniques regarding an instant message (hereinafter referred to as IM) communication that has recently gained attention as one form of the data communication is patent document 4 which will be mentioned later. In this patent document 4, a service control apparatus for controlling the entire IM service receives an IM from one terminal to another terminal, and makes a call to a telephone set provided at the other terminal to notify in speech that a message has arrived, if the other terminal is off-line.

[Patent Document 1]

Japanese Patent Laid-Open No. 2002-44277

[Patent Document 2]

Japanese Patent Laid-Open No. 2002-185387

[Patent Document 3]

Japanese Patent Laid-Open No. 2002-369246

[Patent Document 4]

Japanese Patent Laid-Open No. 2001-313666

### BRIEF SUMMARY OF THE INVENTION

Though various types of mobile communication terminals capable of making the voice communication and the data communication at the same time have been conventionally proposed as described above, no mobile communication terminal employing an IM communication as the data communication and capable of making the voice communication and the IM communication at the same time has been provided. The greatest one of the conceivable reasons is the feature of real time for the voice communication by telephone and the IM communication, in which if any one of them is available, the other may be dispensed with. Therefore, though the invention employing both the IM communication and the voice communication has been proposed, as described in patent document 4, there is no invention in which the voice communication and the IM communication are associated organically. If the voice communication and the IM communication are linked, some unprecedented communications maybe allowed involving responding in the IM communication when receiving a call at the place where there is an obstacle to respond in speech such as within a train, or making a conversation in parallel while transmitting the information unlikely to be conveyed correctly in speech by telephone by way of the IM communication.

This invention has been achieved in the light of the above-mentioned problems, and it is an object of the invention to provide a mobile communication system and method, a mobile communication terminal, a server apparatus and a program in which the voice communication and the IM communication are organically linked.

The invention provides a mobile communication system comprising a plurality of mobile communication terminals capable of performing a voice communication and an IM communication at the same time, and a communication network for interconnecting the plurality of mobile communication terminals, wherein the voice communication and the IM communication are linked under control.

More specifically, in the first mobile communication system, the mobile communication terminal has control means for enabling the voice communication by returning a response to an incoming call, and automatically setting the other terminal originating the incoming call as an IM transmission destination by starting an IM communication application program, if the user inputs a command of using the IM communication at the same time when there is the incoming call in the voice communication.

In the second mobile communication system, the mobile communication terminal has control means for automatically setting the other terminal during service as an IM transmission destination by starting an IM communication application program, if the user inputs a command of using the IM communication at the same time during the service in the voice communication.

In the third mobile communication system, the information for designating the other terminal as the IM transmission destination is the telephone number of the other terminal, and the IM communication application program displays an IM operation screen on a display unit to accept an operation by the user, and upon an instruction of message transmission, sets an IM communication address of the other terminal to a NULL state, and transmits an IM with the telephone number of the other terminal appended to an IM server, in which the IM server sets an IM communication address registered corresponding to the telephone number in the IM to the IM communication address in the NULL state and distributes the IM.

In the fourth mobile communication system, the information for designating the other terminal as the IM transmission destination is an IM communication address registered in storage means of the self terminal corresponding to the telephone number of the other terminal, and the IM communication application program displays an IM operation screen on the display unit to accept an operation by the user, and transmits an IM with the IM communication address of the other terminal set to an IM server, upon an instruction of message transmission.

Also, the invention provides a mobile communication method for use with a mobile communication system comprising a plurality of mobile communication terminals capable of performing a voice communication and an IM communication at the same time, and a communication network for interconnecting the plurality of mobile communication terminals, wherein the voice communication and the IM communication are linked under control.

More specifically, in the first mobile communication method, the mobile communication terminal has control means for enabling the voice communication by returning a response to an incoming call, and automatically setting the other terminal originating the incoming call as an IM transmission destination by starting an IM communication application program, if the user inputs a command of using the IM communication at the same time when there is the incoming call in the voice communication.

In the second mobile communication method, the mobile communication terminal has control means for automatically setting the other terminal during service as an IM transmission destination by starting an IM communication application program, if the user inputs a command of using the IM communication at the same time during the service in the voice communication.

In the third mobile communication method, the information for designating the other terminal as the IM transmission destination is the telephone number of the other terminal, and the IM communication application program displays an IM operation screen on a display unit to accept an operation by the user, and upon an instruction of message transmission, sets an IM communication address of the other terminal to a NULL state, and transmits an IM with the telephone number of the other terminal appended to an IM server, in which the IM server sets an IM communication address registered corresponding to the telephone number in the IM to the IM communication address in the NULL state and distributes the IM.

In the fourth mobile communication method, the information for designating the other terminal as the IM transmission destination is an IM communication address registered in storage means of the self terminal corresponding to the telephone number of the other terminal, and the IM communication application program displays an IM operation screen on the display unit to accept an operation by the user, and transmits an IM with the IM communication address of the other terminal set to an IM server, upon an instruction of message transmission.

Also, the invention provides a mobile communication terminal capable of performing a voice communication and an IM communication at the same time via a communication network, wherein the voice communication and the IM communication are linked under control.

More specifically, the first mobile communication terminal further comprises control means for enabling the voice communication by returning a response to an incoming call, and automatically setting the other terminal originating the incoming call as an IM transmission destination by starting an IM communication application program, if the user inputs a command of using the IM communication at the same time when there is the incoming call in the voice communication.

The second mobile communication terminal further comprises control means for automatically setting the other terminal during service as an IM transmission destination by starting an IM communication application program, if the user inputs a command of using the IM communication at the same time during the service in the voice communication.

In the thirdmobile communication terminal, the information for designating the other terminal as the IM transmission destination is the telephone number of the other terminal, and the IM communication application program displays an IM operation screen on a display unit to accept an operation by the user, and upon an instruction of message transmission, sets an IM communication address of the other terminal to a NULL state and transmits an IM with the telephone number of the other terminal appended to an IM server, in which the IM server has a function of setting an IM communication address registered corresponding to the telephone number in the IM to the IM communication address in the NULL state and distributing the IM.

In the fourth mobile communication terminal, the information for designating the other terminal as the IM transmission destination is an IM communication address registered in storage means of the self terminal corresponding to the telephone number of the other terminal, and the IM communication application program displays an IM operation screen on the display unit to accept an operation by the user, and transmits an IM with the IM communication address of the other terminal set to an IM server, upon an instruction of message transmission.

Also, the invention provides a server apparatus comprising a receiving portion for receiving an IM with a telephone number of the other terminal appended in which an IM communication address is set to a NULL state, a storage portion for storing a correspondence table between the telephone number and the IM communication address, a retrieval portion for retrieving the IM communication address corresponding to the telephone number appended to the received IM from the correspondence table, a control portion for generating an IM for distribution employing the IM communication address retrieved by the retrieval portion, and a transmitting portion for transmitting the generated IM for distribution.

[Operation]

In this invention, since the voice communication and the IM communication are linked under control, the voice communication and the data communication can be linked. Particularly, the first mobile communication system and method and mobile communication terminal, when there is a call incoming in the voice communication, if the user inputs a command of using the IM communication at the same time, an automatic operation is performed by returning a response in the voice communication, starting the IM communication application program, and performing a processing for setting the other terminal originating the incoming call to the IM transmission destination. Therefore, the user is greatly relieved of the load, and the response in the IM communication is rapidly returned. Also, the second mobile communication system and method and mobile communication terminal, if the user inputs a command of using the IM communication at the same time during service in the voice communication, an automatic operation is performed by starting the IM communication application program, and performing a processing for setting the other terminal during service to the IM transmission destination. Therefore, the user is greatly relieved of the load, and the response in the IM communication is rapidly returned. Furthermore, in the third mobile communication system and method, mobile communication terminal and server apparatus, even if the IM communication address of the other terminal is unknown at the terminal side, the IM communication is allowed, employing the telephone number of the other terminal.

### BRIEF DESCRIPTION OF THE DRAWINGS

FIG. 1 is a block diagram of a mobile communication system according to a first embodiment of the present invention;

FIG. 2 is an appearance view of a mobile communication terminal according to this invention;

FIG. 3 is a block diagram showing a hardware configuration example of the mobile communication terminal according to the invention;

FIGS. 4A and 4B show the IM data formats;

FIGS. 5A and 5B are flowcharts showing an operation for processing an incoming call and an outgoing call in the voice communication at the mobile communication terminal according to the invention;

FIGS. 6A to 6C are views showing the display examples on the screen of a display unit at the mobile communication terminal according to the invention;

FIG. 7 is a block diagram showing a configuration example of an IM server according to the invention;

FIG. 8 is a flowchart showing an operation for processing the IM data received from the terminal in an IM server; and

FIG. 9 shows pieces of information stored in a flash memory of the mobile communication terminal according to another embodiment of the invention.

### DETAILED DESCRIPTION OF THE PREFERRED EMBODIMENTS

First Embodiment

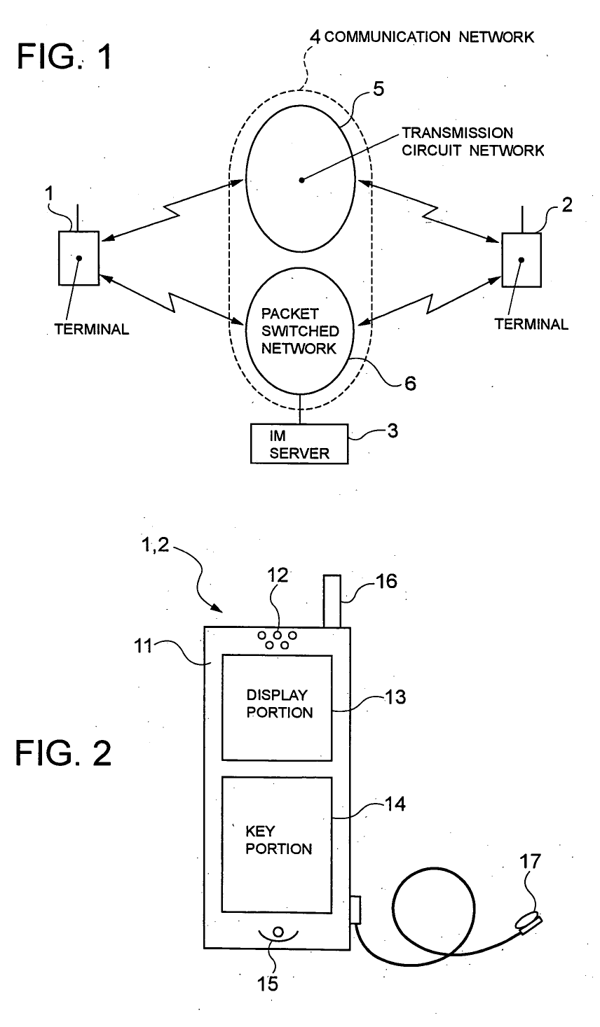

Referring to FIG. 1, a mobile communication system according to a first embodiment of the invention comprises a plurality of mobile communication terminals (hereinafter simply referred to as terminals) 1, 2, an IM server 3, and a communication network 4 for interconnecting the terminals and the IM server. The communication network 4 is composed of a transmission circuit network (voice network) 5 and a packet network 6 in this embodiment. However, in a system capable of making the voice communication through an IP network such as the Internet by transforming voice information into IP packets by VOIP (Voice over IP) technique, the communication network 4 may be constituted of the Internet, and so forth.

The terminals 1 and 2 has a function of making the voice communication with the other terminal via the circuit network 5 and a function of making the IM communication with the other terminal through the IM server 3 via the packet network 6. The IM server 3 has a function of receiving an IM from the terminals 1, 2, and transmitting an IM to a terminal of designated destination in real time.

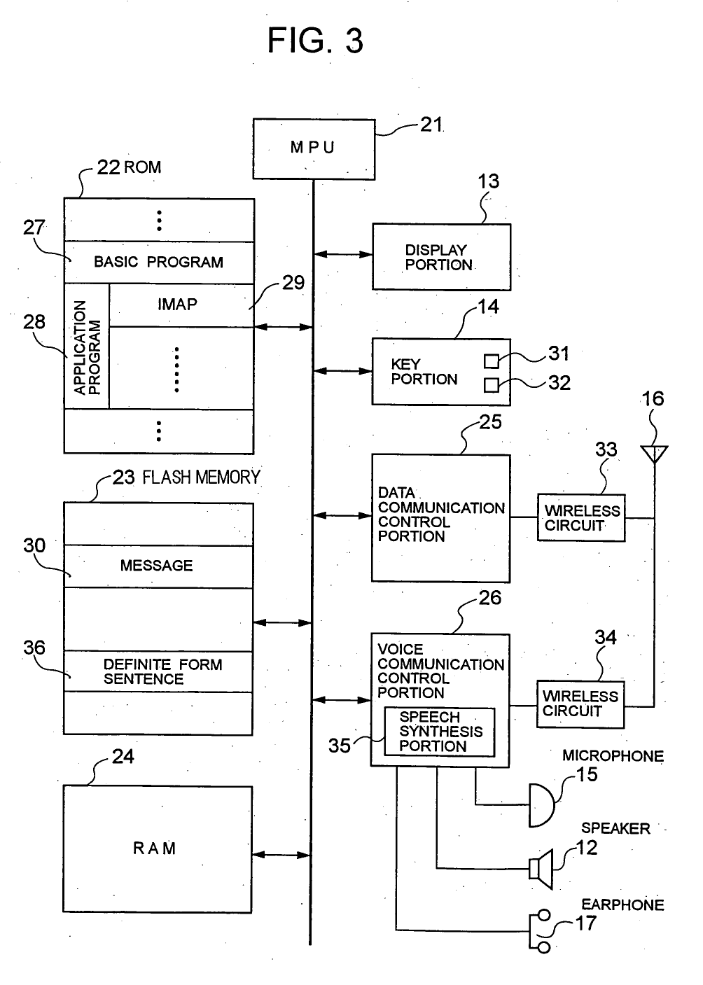

FIG. 2 is an appearance view of an example of the terminals 1, 2. This example is a portable telephone set, in which a speaker 12, a display portion 13 such as LCD, a key portion 14 with various keys arranged, and a microphone 15 are disposed on a front panel 11. Reference numeral 16 denotes an antenna, and 17 denotes an earphone, which is connected to a terminal main body in FIG. 2. The earphone 17 may be an earphone microphone having a microphone integrated.

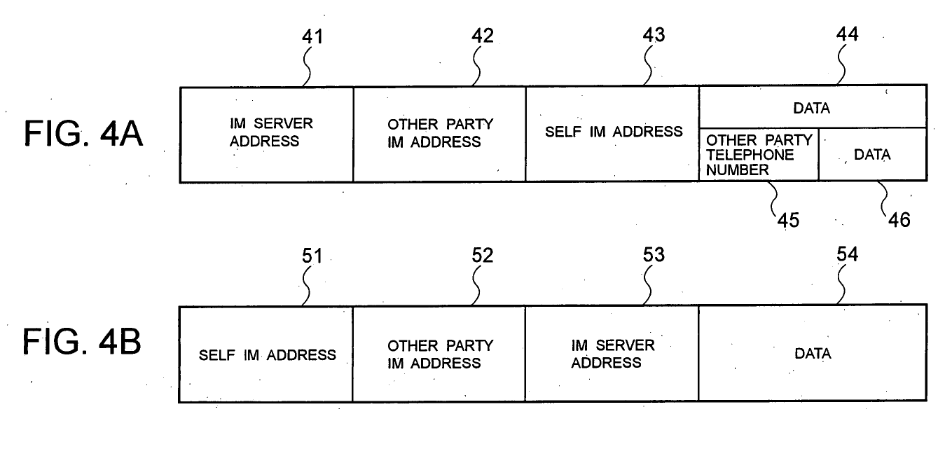

FIG. 3 shows a hardware configuration example of the terminals 1, 2. An MPU 21 controls the overall terminal, and is connected to a ROM 22, a flash memory 23, a RAM 24, a display portion 13, a key portion 14, a data communication control portion 25, and a voice communication control portion 26.

The ROM 22 is a read-only non-volatile memory for storing various kinds of programs executed by the MPU 21 and necessary data. The programs includes a-basic program 27 composed of various control programs such as an OS and a call control program and the application programs 28, in which an IM application program 29 (hereinafter referred to as an IMAP) is packaged as one of the application programs 28 in this embodiment.

The flash memory 23 is a rewritable non-volatile memory employed to store various kinds of data that the user wants to store in non-volatile manner. In this embodiment, the flash memory 23 stores a message 30 for response in speech synthesis when there is a call incoming in the voice communication and the definite form sentences 36 available in the IM communication. The message 30 may be a text sentence such as “Hello, this is ◯◯ speaking. Not responding in speech now, and responding with an instant message from this side. If your terminal is off-line in presence, turn it on-line. As your voice can be heard, you may speak on your business, please.” (◯◯ is the person's name). Also, the definite form sentences 36 may be text sentences such as “Yes, it is.” and “No, it is not.”, and so forth.

The RAM 24 is employed as a temporary storage area or a work area required for the MPU 21 to execute the program and an area for temporarily storing various kinds of data.

The display portion 13 is employed to present various kinds of information to the user at the terminal. In this embodiment, an IM operation screen for editing the transmitting IM and displaying the received IM, and so forth are displayed. Also, an IM response button for selecting whether or not to respond in the IM communication when there is a call incoming in the voice communication is also displayed.

The key portion 14 has the numeric keys and various function keys. Like the ordinary portable telephone set, kanji and hiragana can be input by combining the keys in the key portion 14. The keys 31 and 32 as shown in FIG. 3 indicate part of the keys disposed in the key portion 14. The key 31 is an off-hook key that is operated to respond only in the voice communication when there is a call incoming in the voice communication. In contrast, the key 32 is an IM response key that is operated to respond using the IM communication when there is a call incoming in the voice communication. Instead of operating the IM response key 32, the IM response button displayed on the display portion 13 may be selected. If the IM response key 32 is operated during service, it is construed to instruct not only the voice communication but also the IM communication with the other party during service.

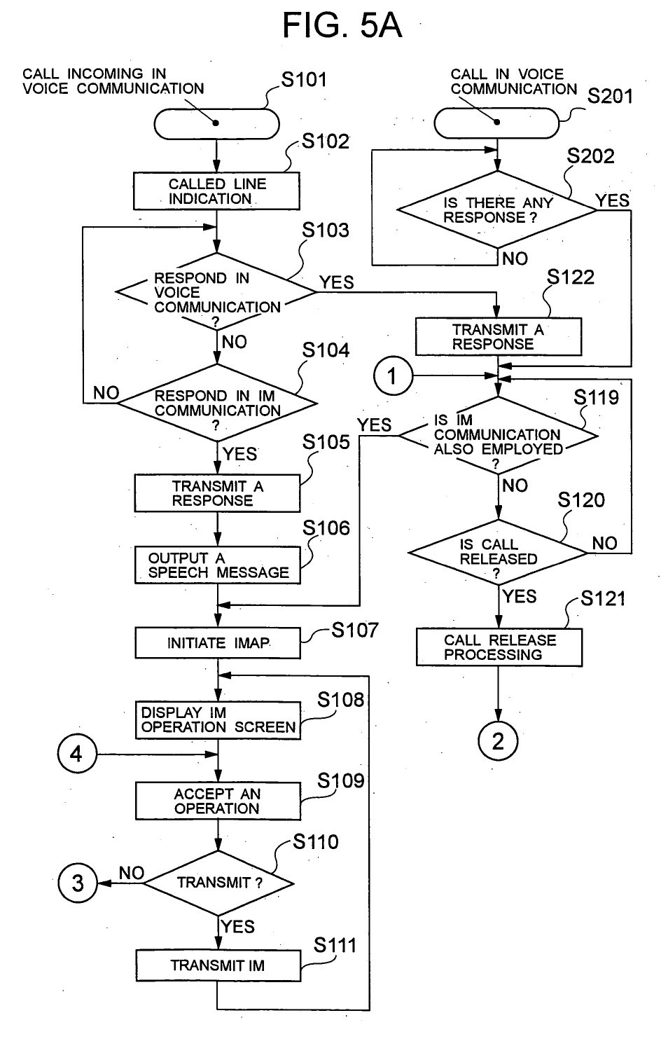

The data communication control portion 25 controls the data communication, and is connected through a wireless circuit 33 to an antenna 16 to transmit and receive packet IM data. FIG. 4A shows a transmission format of IM data transmitted by the data communication control portion 25, and FIG. 4B shows a reception format of IM data received by it.

In FIG. 4A, an IM server address 41 is an address of the IM server 3 that is the destination of IM data, an other party IM address 42 is an IM address of the other terminal to which the IM data is finally delivered, a self IM address 43 is an IM address of the self terminal transmitting the IM data, and data 44 is a message main portion. When the other party IM address 42 is unknown, the other party IM address 42 is set to NULL, and a telephone number 45 of the other terminal is set at an initial byte location of the data 44, followed by a message main body 46.

In FIG. 4B, a self IM address 51 is an IM address of the self terminal that is the destination of IM data, an other party IM address 52 is an IM address of the other terminal transmitting the IM data, an IM server address 53 is an address of the IM server 3, and data 54 is a message main portion.

Referring to FIG. 3 again, a voice communication control portion 26 controls the communication of voice information, and is connected through a wireless circuit 34 to the antenna 16, and connected to the microphone 15, the speaker 12 and the earphone 17. This voice communication control portion 26 comprises internally a voice synthesis portion 35 for transforming a message sentence into a synthesized speech, whereby a voice signal synthesized by the voice synthesis portion 35 is transmitted instead of an input voice from the microphone 15.

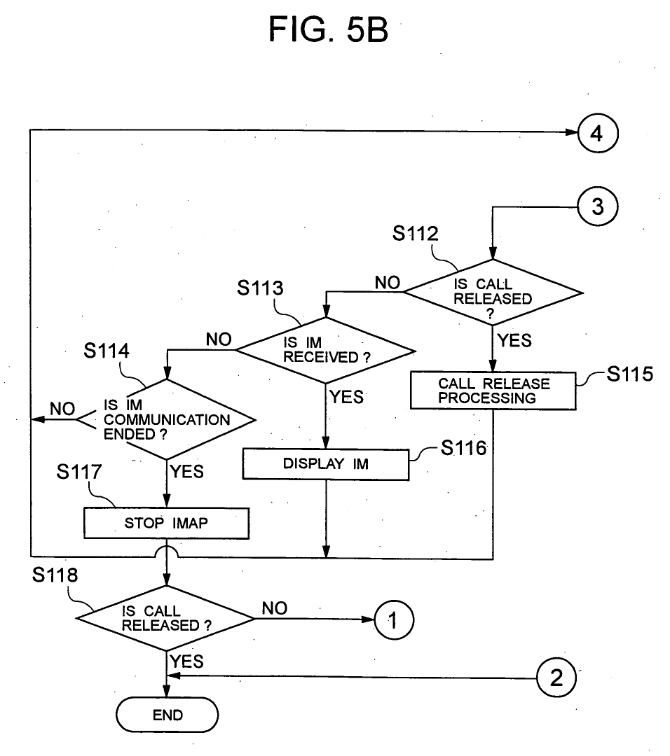

FIGS. 5A and 5B are flowcharts showing a processing example when an incoming call and a call occur in the voice communication at the terminals 1 and 2. The processing as indicated in this flowchart is performed by the MPU 21 executing a program stored in the ROM 22. Referring to FIGS. 5A and 5B, first of all, the operation when there is a call incoming in the voice communication will be described. For the convenience of explanation, the operation on the terminal 1 is supposed when the incoming call is made from the terminal 2 to the terminal 1.

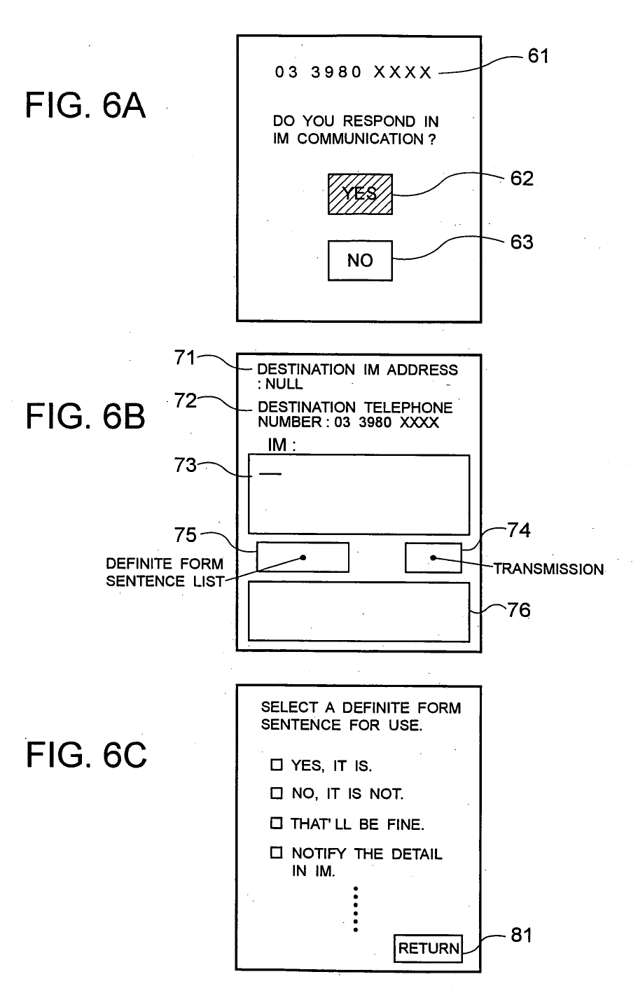

The data communication control portion 25 of terminal 1 receives and detects an incoming signal from the circuit network 5 (step S101), and detects and notifies the MPU 21 that there is a call incoming and the telephone number of terminal 2 transmitted from the circuit network 5 owing to an originator telephone number notification function. The MPU 21 indicates a call incoming by singing of a call incoming tone with a thunder, not shown, or by vibration with a vibrator. A telephone number 61 of terminal 2 that is a calling party and the selection buttons 62, 63 for instructing whether or not to respond in the IM communication are displayed on the display portion 13 (step S102), as shown in FIG. 6A. Then, the operation waits for an instruction from the user (steps S103, S104). In a state where the IM communication with the calling party is not allowed immediately, such as when an IMAP 29 is already initiated at the time of call incoming and the user edits the transmitting IM on the display portion 13, the call incoming is only indicated without displaying the screen as shown in FIG. 6A, and the linkage with the IM communication is deferred until the IMAP 29 is suspended.

In FIG. 6A, a YES button 62 is operated when responding in the IM communication (IM response button), and a NO button 63 is operated when responding in the voice communication alone as usual. In an initial state, the cursor is located on the YES button 62, whereby the YES button 62 is selected by performing a deterministic operation with the key portion 14.

If the user selects the YES button 62 or operates the IM response key 32 on the key portion 14, the MPU 21 judges that a response in the IM communication is instructed (YES at step S104). Then, the voice communication control portion 26 transmits a response signal to the circuit network 5 to enable the voice communication (step S105), and forwards a message 30 stored in the flash memory 30 to the speech synthesis portion 35 to transmit the synthesized speech to the calling party (terminal 2) (step S106). Thereby, a voice message indicating “Hello, this is ◯◯ speaking. Not responding in speech now, and responding with an instant message from this side. If your terminal is off-line in presence, turn it on-line. As your voice can be heard, you may speak on your business, please.” is transmitted to the terminal 2. The user of terminal 1 can listen to a matter of business from the user at the terminal 2 with the ear closer to the speaker 12, but since the user employs the display portion 13 in making a response with the IM, the user usually listen to a speech of the other party, employing the earphone 17.

At the same time, the MPU 21 initiates the IMAP 29 to notify the originator telephone number (telephone number of terminal 2) to the IMAP 29 (step S107). The initiated IMAP 29 notifies the IM server 3 that the presence of terminal 1 is turned on-line using presence data transmitted through the wireless circuit 34 and the antenna 16 by the voice communication control portion 26. Also, the IMAP 29 displays an IM operation screen as shown in FIG. 6B on the display portion 13 (step S108), and accepts various kinds of operation from the user to perform the processing in accordance with an accepted operation (step S109).

In FIG. 6B, a destination IM address 71 is an IM address set in the other party IM address 42 in the transmission format of FIG. 4, and set to NULL at present. A destination telephone number 72 is the telephone number of originator (telephone number of terminal 2) that is set. When the destination IM address 71 is NULL, the IMAP 29 operates to set the destination telephone number 72 to the other party telephone number 45 in the transmission format of FIG. 4. An IM edit column 73 is a space for editing a transmitting message and a blank. The cursor is located at the initial position of the IM edit column 73. A text input by operating the key portion 14 is displayed in this IM edit column 73 as a monitor, thereby allowing the user to edit arbitrary message sentence. A transmission button 74 is a button for instructing the transmission of IM. A definite form sentence list button 75 is a button for instructing the display of a list of definite form sentences. If this button 75 is operated, the IMAP 29 reads a definite form sentence 36 stored in the flash memory 23, and displays a definite form sentence list screen as shown in FIG. 6C on the display portion 13. A selection box is provided at the top of each definite form sentence, in which if the cursor is positioned in the selection box, and a deterministic operation is made by the key portion 14, the selected definite form sentence is set in the IM edit column 73 and the screen of FIG. 6B appears again. If a return button 81 is operated, the display returns to the screen of FIG. 6B without selecting the definite form sentence. Also, a receiving IM display column 76 is a column for displaying the IM received from the other terminal.

The user of terminal 1 edits a response content in the IM edit column 73 for a matter of business from the other party that the user listens to through the earphone 17, employing a definite form sentence such as “Yes, it is.”, “No, it is not.” or “That'll be fine.” or inputting any text sentence from the key portion 14, and then operates the transmission button 74. Then, the IMAP 29 detects an operation of the transmission button 74 (YES at step S110) and performs the IM transmission (step S111). Specifically, the transmission data is created in which the IM server address 41 is set to the preset address of the existent IM server 3, the other party IM address 42 is set to NULL, the self IM address 43 is set to the IM address of the self-terminal 1, the other party telephone number 45 is set to the telephone number of terminal 2, and data 46 is set to the text sentence set in the IM edit column 73, and passed to the data communication control portion 25 to instruct transmission of data. The data communication control portion 25 transmits the IM data through the wireless circuit 33 from the antenna 16 to the packet network 6 in accordance with a predetermined communication protocol. The packet network 6 delivers the received IM data to the IM server 3 at its IM server address 41, and the IM server 3 delivers this IM to the terminal 2. At this time, the operation of the IM server 3 will be described later in detail in connection with a configuration example of the IM server 3.

Transmission of the IM from terminal 1 is not only performed once, but also may be repeated many times (steps S108 to S111). In parallel with these processings, the MPU 21 determines whether or not the voice communication between terminal 1 and terminal 2 is ended (call release) (step S112), whether or not the terminal 1 receives the IM from the other terminal (step S113), and whether or not the user of terminal 2 makes an operation of stopping the IMAP 29 (step S114).

When any one of the terminals 1 and 2 is on-hook and call released, the MPU 21 performs a call release processing (step S115). Since the IM communication is continued even if the voice communication is ended, control is returned to step S109.

In the case of receiving at the data communication control portion 25 the IM data through the antenna 16 and the wireless circuit 33 from the other terminal in the reception format as shown in FIG. 6B, the data communication control portion 25 temporarily stores the received data in the RAM 24, and displays the contents of data 54 on the display portion 13 to present the contents of IM to the user at the terminal 1 (step S116). And control is returned to step S109.

When the stop of the IMAP 29 is instructed by an operation on the key portion 14, the voice communication control portion 26 notifies presentation data indicating that the IMAP 29 is turned off-line to the IM server 3, so that the IMAP 29 stops the operation (step S117). The MPU 21 determines whether or not the voice communication is also ended (step S118). If the voice communication is ended, the process of FIG. 5 is ended. If the voice communication is continued, the MPU 21 determines whether or not the simultaneous use of the IM communication is instructed by an operation of the IM response key 32 on the key portion 14 (step S119), and whether or not the voice communication between terminal 1 and terminal 2 is ended (step S120). If the voice communication between terminal 1 and terminal 2 is ended, a call release process is performed (step S121), and the process of FIG. 5 is ended. On the other hand, if the IM response key 32 is operated during voice communication with the terminal 2, control transfers to step S107. Thereby, the IMAP 29 is initiated again, and the telephone number of the other terminal 2 during voice communication is notified to the IMAP 29. Consequently, the IM operation screen is displayed on the display portion 13, as shown in FIG. 6B, whereby the voice communication and the IM communication are again employed together to communicate with the terminal 1.

On the other hand, when there is a call incoming from the terminal 2, if the user operates the NO button 63 in FIG. 6A, or the off-hook key 31 on the key portion 14, the MPU 21 judges to respond in the voice communication alone (YES at step S103), and controls the voice communication control portion 26 to transmit a response signal through the wireless circuit 34 and the antenna 16 to the circuit network 5, thereby enabling the voice communication with the terminal 2 (step S122). And control transfers to step S119. In the following, communication is enabled with the terminal 2, employing the IM communication together, if necessary.

Referring to FIG. 5, the operation when there is an outgoing call in the voice communication will be described below. For the convenience of explanation, it is supposed that the terminal 1 makes a call to the terminal 2.

If the user inputs the telephone number of terminal 2 by operating the key portion 14 and presses the off-hook key 31, the MPU 21 passes the telephone number of terminal 2 to the voice communication control portion 26. Then, the voice communication control portion 26 transmits a calling signal through the wireless circuit 34 from the antenna 16 to the circuit network 5 (step S201). The circuit network 5 transmits an incoming signal to the terminal 2 in accordance with the received calling signal, and transmits a response signal to the terminal 1 if the terminal 2 responds to this incoming signal. If the MPU 21 confirms that the terminal 2 responds (YES at step S202), the control is transferred to step S119. In the following, communication is enabled with the terminal 2, employing the IM communication together, if necessary, at the same time with the call incoming. Herein, when the terminal is on the calling side, the telephone number of the other terminal used in making a call is notified from the MPU 21 to the IMAP 29 at step S107, and the IMAP 29 employs the notified telephone number as the destination telephone number 72 of FIG. 6B.

A configuration example and the operation of the IM server 3 will be described below.

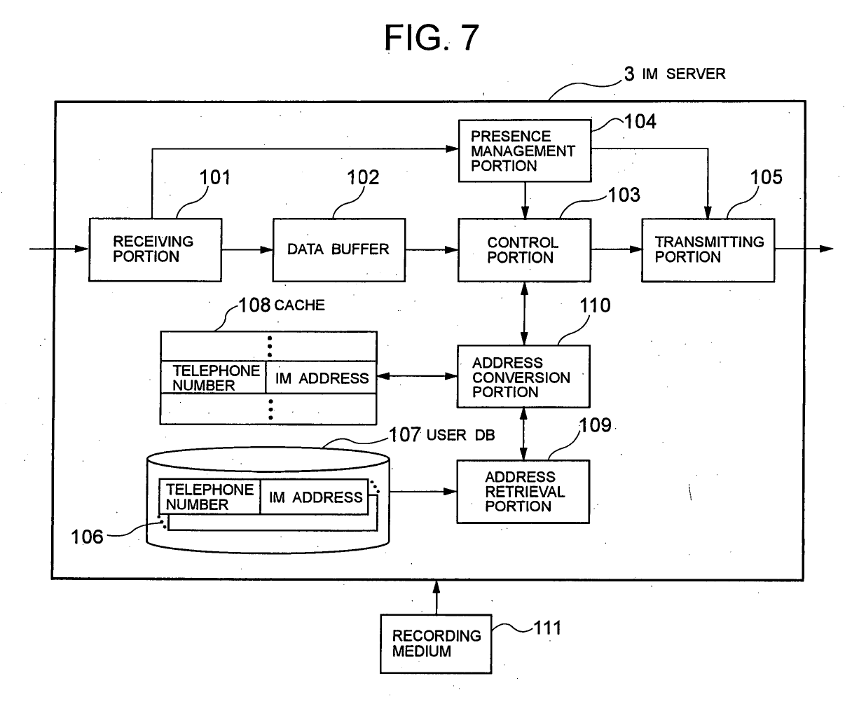

Referring to FIG. 7, the IM server 3 as one example comprises a receiving portion 101 for receiving data from the terminals 1, 2, a data buffer 102 for temporarily storing the IM received from the terminals 1, 2, a control portion 103 for controlling distribution of the IM stored in the data buffer 102, a presence management portion 104 for managing the presence of each terminal based on the presence data (on-line or off-line data) of the terminals 1, 2 received by the receiving portion 101 and notifying the presence data of the other terminal to the on-line terminal, a transmitting portion 105 for transmitting the IM received from the terminal and the presence data of the terminal to the other terminal, a user database 107 for storing a correspondence table 106 between the telephone number and the IM address of the terminals 1, 2, a cache 108 for storing the copy of a part of the correspondence table 106, an address retrieval portion 109 for retrieving the IM address corresponding to the telephone number from the correspondence table 106, and an address conversion portion 110 for receiving the telephone number from the control portion 103, and checking whether or not the IM address corresponding to its telephone number exists in the cache 108, in which if the IM address exists (also called a hit), returning the existent IM address to the control portion 103, or if it does not exist (also called a mishit), passing the telephone number to the address retrieval portion 109 to request the retrieval and returning the retrieval result to the control portion 103.

This IM server 3 is implemented by a computer such as a workstation or a personal computer, and a server program. The server program is provided by being stored in a computer readable recording medium 111 such as a magnetic disk or a CD-ROM. This server program is read by the computer, when the computer constituting the IM server 3 is started up, and so forth, and controls the operation of the computer so that the receiving portion 101, the control portion 103, the presence management portion 104, the transmitting portion 105, the address conversion portion 110 and the address retrieval portion 109 are implemented on the computer.

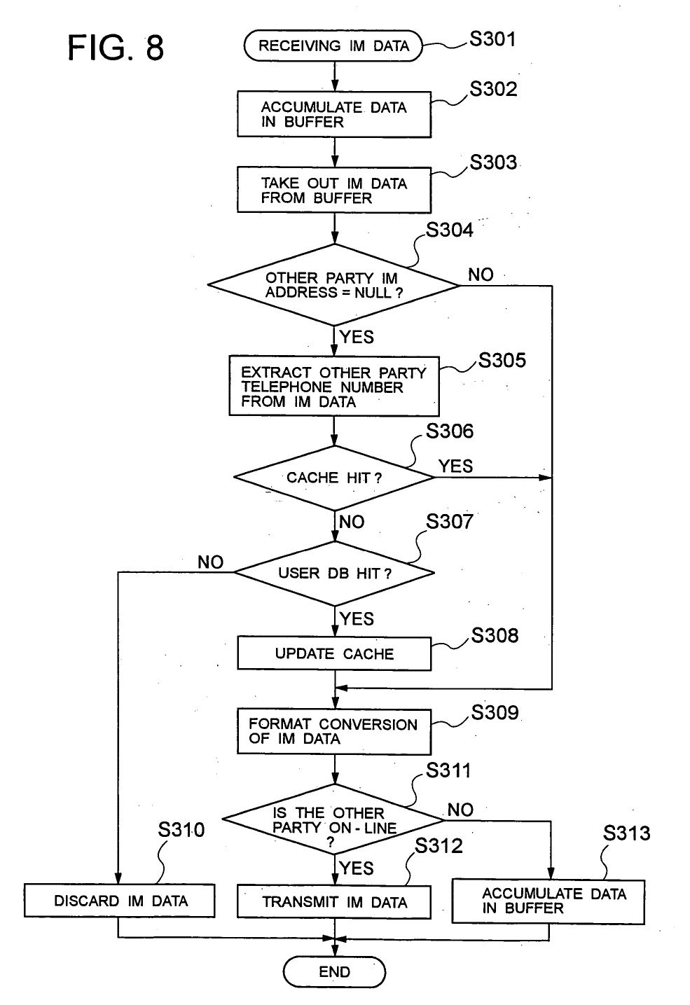

FIG. 8 is a flowchart showing a processing example of the IM server 3 when the IM data is received from the terminal. In the following, the operation of the IM server 3 will be described below, taking the case where the IM data destined to the terminal 2 is received from the terminal 1 as an example.

The IM server 3 receives the IM data transmitted from the terminal 1 in the receiving portion 101 (step S301), and once accumulates the IM data in the data buffer 102 (step S302). Then, the control portion 103 takes out the IM data received from the data buffer 102 (step S303) and checks whether or not the other party IM address (42 in FIG. 4A) is NULL (step S304). If the other party IM address is not NULL but set up, the procedure proceeds to step S309, where the received IM data is converted into the IM data for transmission in the reception format as shown in FIG. 4B. On the other hand, if the other party IM address is NULL, the other party telephone number (45 in FIG. 4A) is extracted from the IM data (step S305), and passed it to the address conversion portion 110.

The address conversion portion 110 checks whether or not the correspondence information between the same other party telephone number and the IM address exists in the cache 108 (step S306). If the correspondence information exists, the corresponding IM address is returned to the control portion 103. If not, the other party telephone number is passed to the address retrieval portion 109.

The address retrieval portion 109 checks whether or not the correspondence information between the same other party telephone number and the IM address is recorded in the correspondence table 106 of the user database 107 (step S307). If the correspondence information exists, the corresponding IM address is returned to the address conversion portion 110. Then, the address conversion portion 110 registers the correspondence information between the returned IM address and the other party telephone number in the cache 108 (step S308) and returns the returned IM address to the control portion 103. On the other hand, if not, the control portion 103 is notified through the address conversion portion 110 that the correspondence information does not exist, and discards the IM data received at the present time (step S310).

On the other hand, when the IM address corresponding to the other party telephone number is returned, the control portion 103 converts the received IM data into the IM data for transmission in the reception format as shown in FIG. 6B, employing the returned IM address (step S309). And the control portion 103 determines whether the presence of the terminal 2 having the returned IM address is on-line or off-line, based on the current presence data of each terminal managed by the presence management portion 104 (step S311). If the terminal 2 is on-line, the control portion 103 controls the transmitting portion 105 to transmit the IM data to the terminal 2 over the packet network 6 (step S312). If the terminal 2 is off-line, the IM data is returned to the data buffer 102 (step S313). The IM data returned to the data buffer 102 is again taken out by the control portion 103 and transmitted to the terminal 2, when the terminal 2 becomes on-line again.

A few communication examples using the mobile communication system according to this embodiment will be given below.

The terminal 1 is a portable telephone set possessed by the user “Suzuki”, and the terminal 2 is a portable telephone set possessed by the user “Tanaka”. Suzuki and Tanaka are both users of the IM service, in which the correspondence information between own telephone number and own IM address is registered beforehand in the correspondence table 106 of the user database 107 in the IM server 3. In the morning of one day, Suzuki made a phone call from the terminal 1 to the terminal 2 for Tanaka. Tanaka was in the train and had an obstacle to respond in speech. Tanaka set the earphone 17 and decided to respond in the IM communication by depressing the YES button 62 of FIG. 6A displayed on the display portion 13 at the self terminal 2 at the time of call incoming. At this time, the message 30 registered beforehand in the flash memory 23 is transformed into a voice message by the speech synthesis portion 35, so that the voice message “Hello, this is Tanaka speaking. Not responding in speech now, and responding with an instant message from this side. If your terminal is off-line in presence, turn it on-line. As your voice can be heard, you may speak on your business, please.” is automatically sent out from the terminal 2 to the terminal 1. Also, the IMAP 29 is initiated, the presence information “on-line” of the terminal 2 is notified to the IM server 3, and the IM operation screen of FIG. 6B appears on the display portion 13, so that the operation is immediately ready for transmission of the IM.

On the other hand, Suzuki listening to the voice message understood the state of affairs, and initiated the IMAP 29. by depressing the IM response key 32 at the self terminal 1. Thereby, the IM operation screen of FIG. 6B appears on the display portion 13 at the terminal 1, so that the operation is immediately ready for confirming the IM received from the terminal 1. And Suzuki spoke a message “I wants to meet you at the usual place at one o'clock PM today. How about you?”. And Suzuki waited for the IM from Tanaka to arrive.

Tanaka listening to the matter of business through the earphone 17 called a definite form sentence “That'll be fine.” into the IM edit column 73, and made a response of agreement by depressing the transmission button 74. At this time, the IM data is transmitted from the terminal 2 to the IM server 3 in the transmission format as shown in FIG. 4A, in which the other party IM address 42 is NULL, and the other party telephone number 45 is set to the telephone number of Suzuki. The IM server 3 acquires the IM address of Suzuki from the correspondence relation between the telephone number of Suzuki and the IM address stored in the user database 107 and solves the address. Then, the IM server 3 confirms that the presence of the terminal 1 for Suzuki is on-line, and transmits the received IM of “That'll be fine.” to the terminal 1.

The transmitted IM is received at the terminal 2 for Suzuki, and displayed in the received IM display column 76 on the display portion 13, as shown in FIG. 6B. Suzuki knew that Tanaka agreed, seeing this display, expressed cordial thanks, and rang off.

Just before noon of that day, Tanaka remembered a patent gazette to be brought by Suzuki, and made a phone call from the terminal 2 to the terminal 1 for Suzuki. Suzuki was in a situation of responding in speech, and made a response by operating the off-hook key 31 to try to hear the number of patent gazette informed in speech from Tanaka. But due to the noisy surroundings and bad receiving conditions, Suzuki told “Send the correct number in the IM” in speech, and operated the IM response button 32. Thereby, the IM operation screen as shown in FIG. 6B appeared on the display portion 13 at the terminal 1 for Suzuki, so that the operation was immediately ready for confirming the IM transmitted from Tanaka. On the other hand, Tanaka operated the IM response button 32 to call the IM operation screen as shown in FIG. 6B on the display portion 13 at the terminal 2, inputted “Patent No. X214692” in the IM edit area 73 by operation of the key portion 14, and depressed the transmission button 74. Thereby, the IM of “Patent No. X214692” was transmitted from the terminal 2 for Tanaka to the terminal 1 for Suzuki through the IM server 3 and displayed on the display portion 13 at the terminal 2 for Suzuki. Suzuki talked with Tanaka for today's arrangement for a while until the IM was transmitted. Suzuki received the IM, knew the correct patent number from the display content, and rang off, saying “Delivered certainly. I'll prepare.”

In this way, according to this embodiment, the voice communication and the IM communication are organically linked to make communications.

Second Embodiment

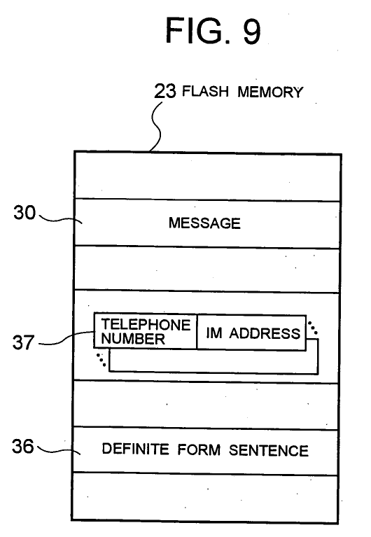

Though the IM server 3 solely solved the IM address corresponding to the telephone number in the first embodiment, the correspondence table 37 between the telephone number and the IM address is stored in the flash memory 23 for the terminals 1, 2 as shown in FIG. 9. The IM address which can be solved by the correspondence table 37 is solved at the terminal side, or otherwise solved at the IM server 3 in the second embodiment. Specifically, when the IMAP 29 is initiated at step S107 in FIG. 5, the telephone number of the other terminal in the voice communication is notified to the IMAP 29 in the first embodiment, whereas the MPU 21 checks whether or not the IM address corresponding to the telephone number of the other terminal is stored in the correspondence table. And if the IM address is stored in it, the IM address is notified to the IMAP 29 in the second embodiment. The IMAP 29 displays the notified IM address as the other party IM address 71 of FIG. 6B, which is set to the other party IM address of FIG. 4A at the time of transmitting the IM.

The registration of the telephone number and the IM address into the correspondence table 37 of the flash memory 23 can be made by operating the key portion 14. Also, when the user at terminal 1 makes a call to terminal 2 and the IM data is transmitted from terminal 2 to terminal 1, the terminal 1 knows the IM address corresponding to the telephone number of terminal 2 from the received other party IM address 52 of FIG. 4B, whereby the MPU 21 may automatically register it in the correspondence table 37 as described in the first embodiment.

In another embodiment, the processing for acquiring the IM address from the telephone number may be performed at the terminal side by deleting all the components (address conversion portion 110, address retrieval portion 109, cache 108 and correspondence table 106 of user database) regarding the function of solving the IM address from the IM server 3 in the second embodiment.

The instance of linking the voice communication and the instant message communication has been described above, but other data communications may be performed at the same time.

As described above, this invention provides the following effects.

The voice communication and the IM communication are organically linked. Its reason is that the voice communication and the IM communication are linked under control.

The user is greatly relieved of the load, and the response in the IM communication is rapidly returned. Its reason is that when there is a call incoming in the voice communication, a response in the voice communication, starting the IM communication application program, and performing a processing for setting the other terminal originating the incoming call to the IM transmission destination, are automatically performed by inputting a command of the user of using the IM communication at the same time. And, the other reason is that when there is a call incoming in the voice communication, starting the IM communication application program, and performing a processing for setting the other terminal during service to the IM transmission destination are automatically performed by inputting a command of the user of using the IM communication at the same time during service in the voice communication.

Even if the IM communication address of the other terminal is unknown at the terminal side, the IM communication is allowed, employing the telephone number of the other terminal. Its reason is that the server apparatus transforms the telephone number into the IM address.

From the above description, it is possible to practice some unprecedented communications simply and rapidly, involving responding in the IM communication when receiving a call at the place where there is an obstacle to respond in speech such as within a train, or transmitting the information unlikely to be conveyed correctly in speech by telephone by way of the IM communication.

What is claimed is:

1. A mobile communication system comprising:
a plurality of mobile communication terminals capable of performing a voice communication and an instant message communication at the same time; and
a communication network for interconnecting said plurality of mobile communication terminals;
wherein the voice communication and the instant message communication are linked under control.

2. The mobile communication system according to claim 1, wherein said mobile communication terminal has control means for enabling the voice communication by returning a response to an incoming call, and automatically setting the other terminal originating said incoming call as an instant message transmission destination by starting an instant message communication application program, if the user inputs a command of using the instant message communication at the same time when there is said incoming call in the voice communication.

3. The mobile communication system according to claim 1, wherein said mobile communication terminal has control means for automatically setting the other terminal during service as an instant message transmission destination by starting an instant message communication application program, if the user inputs a command of using the instant message communication at the same time during said service in the voice communication.

4. The mobile communication system according to claim 2, wherein the information for designating said other terminal as the instant message transmission destination is the telephone number of said other terminal, and said instant message communication application program displays an instant message operation screen on a display unit to accept an operation by the user, and upon an instruction of message transmission, sets an instant message communication address of said other terminal to a NULL state, and transmits an instant message with the telephone number of said other terminal appended to an instant message server, in which said instant message server sets an instant message communication address registered corresponding to the telephone number in the instant message to the instant message communication address in said NULL state and distributes the instant message.

5. The mobile communication system according to claim 2, wherein the information for designating said other terminal as the instant message transmission destination is an instant message communication address registered in storage means of the self terminal corresponding to the telephone number of said other terminal, and said instant message communication application program displays an instant message operation screen on said display unit to accept an operation by the user, and transmits an instant message with the instant message communication address of said other terminal set to an instant message server, upon an instruction of message transmission.

6. A mobile communication method for use with a mobile communication system comprising:
a plurality of mobile communication terminals capable of performing a voice communication and an instant message communication at the same time; and
a communication network for interconnecting said plurality of mobile communication terminals;
wherein the voice communication and the instant message communication are linked under control.

7. The mobile communication method according to claim 6, wherein said mobile communication terminal has control means for enabling the voice communication by returning a response to an incoming call, and automatically setting the other terminal originating said incoming call as an instant message transmission destination by starting an instant message communication application program, if the user inputs a command of using the instant message communication at the same time when there is said incoming call in the voice communication.

8. The mobile communication method according to claim 6, wherein said mobile communication terminal has control means for automatically setting the other terminal during service as an instant message transmission destination by starting an instant message communication application program, if the user inputs a command of using the instant message communication at the same time during said service in the voice communication.

9. The mobile communication method according to claim 7, wherein the information for designating said other terminal as the instant message transmission destination is the telephone number of said other terminal, and said instant message communication application program displays an instant message operation screen on a display unit to accept an operation by the user, and upon an instruction of message transmission, sets an instant message communication address of said other terminal to a NULL state, and transmits an instant message with the telephone number of said other terminal appended to an instant message server, in which said instant message server sets an instant message communication address registered corresponding to the telephone number in the instant message to the instant message communication address in said NULL state and distributes the instant message.

10. The mobile communication method according to claim 7, wherein the information for designating said other terminal as the instant message transmission destination is an instant message communication address registered in storage means of the self terminal corresponding to the telephone number of said other terminal, and said instant message communication application program displays an instant message operation screen on said display unit to accept an operation by the user, and transmits an instant message with the instant message communication address of said other terminal set to an instant message server, upon an instruction of message transmission.

11. A mobile communication terminal capable of performing a voice communication and an instant message communication at the same time via a communication network, wherein the voice communication and the instant message communication are linked under control.

12. The mobile communication terminal according to claim 11, further comprising control means for enabling the voice communication by returning a response to an incoming call, and automatically setting the other terminal originating said incoming call as an instant message transmission destination by starting an instant message communication application program, if the user inputs a command of using the instant message communication at the same time when there is said incoming call in the voice communication.

13. The mobile communication terminal according to claim 11, further comprising control means for automatically setting the other terminal during service as an instant message transmission destination by starting an instant message communication application program, if the user inputs a command of using the instant message communication at the same time during said service in the voice communication.

14. The mobile communication terminal according to claim 12, wherein the information for designating said other terminal as the instant message transmission destination is the telephone number of said other terminal, and said instant message communication application program displays an instant message operation screen on a display unit to accept an operation by the user, and upon an instruction of message transmission, sets an instant message communication address of said other terminal to a NULL state and transmits an instant message with the telephone number of said other terminal appended to an instant message server, in which said instant message server has a function of setting an instant message communication address registered corresponding to the telephone number in the instant message to the instant message communication address in said NULL state and distributing the instant message.

15. The mobile communication terminal according to claim 12, wherein the information for designating said other terminal as the instant message transmission destination is an instant message communication address registered in storage means of the self terminal corresponding to the telephone number of said other terminal, and said instant message communication application program displays an instant message operation screen on said display unit to accept an operation by the user, and upon an instruction of message transmission, transmits an instant message with the instant message communication address of said other terminal set to an instant message server.

16. A server apparatus comprising:
a receiving portion for receiving an instant message with a telephone number of the other terminal appended in which an instant message communication address is set to a NULL state;
a storage portion for storing a correspondence table between the telephone number and the instant message communication address;
a retrieval portion for retrieving the instant message communication address corresponding to said telephone number appended to said received instant message from said correspondence table;
a control portion for generating an instant message for distribution employing the instant message communication address retrieved by said retrieval portion; and
a transmitting portion for transmitting said generated instant message for distribution.

17. A program for a computer to allow a mobile communication terminal to perform a voice communication and an instant message communication at the same time via a communication network, wherein the voice communication and the instant message communication are linked under control, said program further comprising a control step of enabling the voice communication by returning a response to an incoming call, and automatically setting the other terminal originating said incoming call as an instant message transmission destination by starting an instant message communication application program, if the user inputs a command of using the instant message communication at the same time when there is said incoming call in the voice communication.

18. A program for a computer to allow a mobile communication terminal to perform a voice communication and an instant message communication at the same time via a communication network, wherein the voice communication and the instant message communication are linked under control, said program further comprising a control step of automatically setting the other terminal during service as an instant message transmission destination by starting an instant message communication application program, if the user inputs a command of using the instant message communication at the same time during said service in the voice communication.

19. A program for a computer to allow a server apparatus to distribute an instant message, said server apparatus having a storage portion for storing a correspondence table between the telephone number and the instant message communication address, said program comprising:
a receiving step of receiving an instant message with a telephone number of the other terminal appended in which an instant message communication address is set to a NULL state;
a retrieval step of retrieving the instant message communication address corresponding to said telephone number appended to said received instant message from said correspondence table;
a control step of generating an instant message for distribution employing the instant message communication address retrieved at said retrieval step; and
a transmitting step of transmitting said generated instant message for distribution.
